(19) United States
(12) Patent Application Publication
(10) Pub. No.: US 2026/0370900 A1
(43) Pub. Date: Nov. 19, 2026

(54) CROSS-STREAM GUIDANCE CARD FOR MEDIA DATA DISPLAY

(71) Applicant: Tencent Technology (Shenzhen) Company Limited, Shenzhen (CN)

(72) Inventors: Ying QI, Shenzhen (CN); Qian QIU, Shenzhen (CN); Xing LIN, Shenzhen (CN); Hang KANG, Shenzhen (CN); Ziping HE, Shenzhen (CN); Shangzhen ZHENG, Shenzhen (CN); Qingzheng YIN, Shenzhen (CN); Yanguang ZHAO, Shenzhen (CN)

(73) Assignee: Tencent Technology (Shenzhen) Company Limited, Shenzhen (CN)

(21) Appl. No.: 19/722,701

(22) Filed: Jun. 26, 2026

Related U.S. Application Data
(63) Continuation of application No. PCT/CN2025/107538, filed on Jul. 8, 2025.

(30) Foreign Application Priority Data
Aug. 23, 2024 (CN) 202411173797.5

(51) Int. Cl. H04N 21/431; G06F 3/0483; H04N 21/466

(52) U.S. Cl. CPC H04N 21/4314; G06F 3/0483; H04N 21/4668

(57) ABSTRACT

A cross-stream guide card of a plurality of cross-stream guide cards in a first media data stream is displayed when an interactive operation performed on the first media data stream satisfies a media data stream distribution condition. The cross-stream guide card is associated with a second media data stream of a plurality of second media data streams. The media data stream distribution condition indicates whether a watching duration or an interaction frequency associated with the interactive operation meets a threshold value. Target media content in the second media data stream is displayed when a trigger operation is performed by the user on the cross-stream guide card. The target media content includes cover content of the cross-stream guide card. Media content in the second media data stream and the target media content is displayed when a switching operation is performed by the user on the target media content.

### RELATED APPLICATIONS

The present application is a continuation of International Application No. PCT/CN2025/107538, filed on Jul. 8, 2025, which claims priority to Chinese Patent Application No. 202411173797.5, filed on Aug. 23, 2024. The entire disclosure of the prior applications are hereby incorporated by reference.

### FIELD OF THE TECHNOLOGY

This application relates to the field of computer technologies, including a data processing method and apparatus, an electronic device, a computer-readable storage medium, and a computer program product.

### BACKGROUND

In the related art, a user may view media content through a terminal. For the media content displayed on the terminal, the displayed media content may be updated in response to update instructions triggered for the media content, so that the user can view the updated media content. However, in the related art, the media content is displayed in a manner in which the user actively triggers the update instructions, with a single form and a relatively low resource utilization of an electronic device.

### SUMMARY

Embodiments of this disclosure include a data processing method and apparatus, an electronic device, a computer-readable storage medium (e.g., non-transitory computer-readable storage medium), and a computer program product, which may enrich push modes of media content and improve immersive experience of an object watching the media content.

Aspects of the disclosure include a method for data processing. In the method, a cross-stream guide card of a plurality of cross-stream guide cards in a first media data stream is displayed when an interactive operation performed by a user on the first media data stream satisfies a media data stream distribution condition. The cross-stream guide card is associated with a second media data stream of a plurality of second media data streams. The media data stream distribution condition indicates whether a watching duration or an interaction frequency associated with the interactive operation of the user meets a threshold value. Target media content in the second media data stream is displayed when a trigger operation is performed by the user on the cross-stream guide card. The target media content including cover content of the cross-stream guide card. Media content in the second media data stream and the target media content is displayed when a switching operation is performed by the user on the target media content.

Aspects of the disclosure also provide an apparatus for data processing. The apparatus for data processing including processing circuitry configured to implement any of the described methods for data processing.

Aspects of the disclosure also provide a non-transitory computer-readable medium storing instructions which, when executed by a computer, cause the computer to perform any of the described methods.

An aspect of embodiments of this disclosure provides a data processing method, applied to an electronic device, the method including: displaying a cross-stream guide card when an interactive operation on media content in a first media data stream satisfies a media data stream distribution condition, the cross-stream guide card being associated with a second media data stream; displaying target media content in the second media data stream in response to a trigger operation on the cross-stream guide card; and displaying media content in the second media data stream adjacent to the target media content in response to a switching operation on the target media content.

An aspect of embodiments of this disclosure provides a data processing apparatus, including: a card display module, configured to display a cross-stream guide card when an interactive operation on media content in a first media data stream satisfies a media data stream distribution condition, the cross-stream guide card being associated with a second media data stream; a content display module, configured to display target media content in the second media data stream in response to a trigger operation on the cross-stream guide card; and a content switching module, configured to display media content adjacent to the target media content in the second media data stream in response to a switching operation on the target media content.

An aspect of embodiments of this disclosure provides an electronic device, including a processor (an example of processing circuitry), a memory, and a network interface, the processor being connected to the memory and the network interface, the network interface being configured to provide a data communication function, the memory being configured to store a computer program, and the processor being configured to invoke the computer program, so that the computer program, when executed by the processor, causes the electronic device to perform the data processing method provided in embodiments of this disclosure.

An aspect of embodiments of this disclosure provides a computer-readable storage medium, the computer-readable storage medium having a computer program stored therein, and the computer program being configured to be loaded and executed by a processor, so that an electronic device having the processor performs the data processing method provided in embodiments of this disclosure.

An aspect of embodiments of this disclosure provides a computer program product, including a computer program, the computer program being stored in a computer-readable storage medium. A processor of an electronic device reads the computer program from the computer-readable storage medium. The processor executes the computer program, so that the electronic device performs the data processing method provided in embodiments of this disclosure.

In the data processing method provided in embodiments of this disclosure, a cross-stream guide card is displayed when an interactive operation on media content in a first media data stream satisfies a media data stream distribution condition, so that displayed content can be enriched, thereby improving resource utilization of an electronic device. Target media content in a second media data stream is displayed in response to a trigger operation on the cross-stream guide card, so that interaction manners can be enriched, further enriching the displayed content and further improving resource utilization of an electronic device. In response to a switching operation on target media content, media content in the second media data stream adjacent to the target media content may be displayed, so that the displayed content can be further enriched, thereby further improving resource utilization of the electronic device.

The data processing method provided in embodiments of this disclosure can enrich the displayed content and improve resource utilization of the electronic device. In addition, the cross-stream guide card is associated with the second media data stream, and the user can intuitively learn theme information of the media content in the associated second media data stream by using the cross-stream guide card, thereby enriching content push manners. Through the cross-stream guide card, a jump to the second media data stream manner may be more efficient, and the cross-stream guide card may provide diversified media content to attract an object, thereby improving object stickiness and an exposure rate of media content. The second media data stream includes multiple pieces of media content. Successive media content may provide more consistent watching experience, and may improve watching immersion and user experience.

### BRIEF DESCRIPTION OF THE DRAWINGS

To describe the technical solutions in embodiments of this disclosure, drawings required for describing embodiments are briefly described below. In an example, the drawings in the following description show some embodiments of this disclosure, and a person of ordinary skill in the art may still derive other drawings from the drawings.

FIG. 1 is a schematic diagram of a network architecture according to an embodiment of this disclosure.

FIG. 2 is a schematic diagram 1 of a data processing scenario according to an embodiment of this disclosure.

FIG. 3 is a schematic flowchart 1 of a data processing method according to an embodiment of this disclosure.

FIG. 4 is a schematic diagram 2 of a data processing scenario according to an embodiment of this disclosure.

FIG. 5 is a schematic flowchart 2 of a data processing method according to an embodiment of this disclosure.

FIG. 6 is a schematic diagram 3 of a data processing scenario according to an embodiment of this disclosure.

FIG. 7 is a schematic flowchart 3 of a data processing method according to an embodiment of this disclosure.

FIG. 8 is a schematic structural diagram of a data processing apparatus according to an embodiment of this disclosure.

FIG. 9 is a schematic structural diagram of an electronic device according to an embodiment of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Technical solutions in embodiments of this disclosure are described below with reference to accompanying drawings in embodiments of this disclosure. In an example, the described embodiments are some rather than all embodiments of this disclosure. All other embodiments obtained by a person of ordinary skill in the art based on embodiments of this disclosure fall within the scope of this disclosure.

A specific implementation of this disclosure relates to user (object or player) data.

If object data (such as user data) needs to be collected in this disclosure, a prompt interface or a pop-up window is displayed before or during the collection. The prompt interface or the pop-up window is configured to prompt a user that some data is currently being collected. After a confirm operation performed by the user on the prompt interface or the pop-up window is obtained, relevant operations of data obtaining start to be performed. Otherwise, the operation is ended.

Before embodiments of this disclosure are further described, terms involved in embodiments of this disclosure are described. The terms involved in embodiments of this disclosure are applicable to the following explanations.

1) In response to: It is used to indicate a condition or a status on which a performed operation depends. When the condition or the status is satisfied, one or more operations may be performed in real time or with a set delay. Unless otherwise specified, a sequence in which a plurality of operations are performed is not limited.

2) A human-computer interaction interface is configured to provide a human-computer interaction function interface/display an information stream page. For example, a graphical user interface (GUI) is displayed, such as an augmented reality (AR) interface, a virtual reality (VR) interface, a voice user interface (VUI), an interactive projection interface (displaying information on a plane by using a projection technology), an eye motion detection interface (an interface controlled by detecting a line of sight of the user), a holographic interface (a three-dimensional hologram formed by projecting an image through a holographic projection technology, and a three-dimensional image may be seen without wearing special glasses), a multi-modal interface (an interaction interface combining a plurality of interaction manners, such as touch, vision, and hearing), and a brain-machine interface (BMI).

3) Client: It is also referred to as a user side, which is a program corresponding to a server that provides a local service for the user. In addition to some applications that can run locally, the client is generally installed on an ordinary client machine and needs to cooperate with the server to run. In other words, the client requires a corresponding server and service program in a network to provide a corresponding service. In this way, a specific communication connection needs to be established on the client and a server side, to help facilitate a normal operation of an application. The client may be a client that needs to search for a content. For example, the client may be any one of an instant messaging client, a video client (including a short video client), a social client, a game client, or an online education client, which may be set based on an actual use requirement.

4) Media data stream: The media data stream refers to a group of media content (i.e., media information) transmitted in the same direction. For the transmitted media content, the media content has the same information sender and the same information receiver, the media data stream has a corresponding page, and the page is a page displaying the transmitted media content. For ease of understanding, the media data stream is described below in combination with an example. The sender of the media content may be a server, and the receiver of the media content may be a terminal. The terminal is configured to display the media content in the media data stream. In a process in which the user browses the media content in the media data stream by using the terminal, the terminal may receive, in real time or in non-real time, the media content sent by the server, and then display the media content sent by the server.

In a research process, an applicant found the following technical problems in the related art.

Technical problem 1: In the related art, a user may view media content by using a terminal. For the media content displayed on the terminal, the displayed media content may be updated in response to update instructions triggered for the media content, so that the user may view the updated media content. However, in the related art, the media content is displayed in a manner in which the user actively triggers the update instructions. The manner is relatively simple, and resource utilization of an electronic device is relatively low.

Technical problem 2: In a current media content push mechanism, a push algorithm recommends media content similar to a historical media stream to the user. After the recommended similar media stream is watched, a system pushes media content of a random data stream to the user. The user does not know theme information of the pushed data stream. After the user watches for a period of time, the user finds that the pushed data stream does not match the user's preference, which affects the watching experience of the user, and a manner of pushing the random stream is excessively simple.

Technical problem 3: In the related art, in another push manner, another user usually needs to share a link, and the user can watch by clicking the shared link. This manner relies on active sharing by another user, and can push single media content once, thereby resulting in a significant limitation and low user immersion. Alternatively, the user actively selects a type of a media stream that needs to be watched, for example, opens a social information page, or follows a list, a personal home page, or the like. This manner relies on active watching by the user, thereby resulting in a great display form difference and low user immersion.

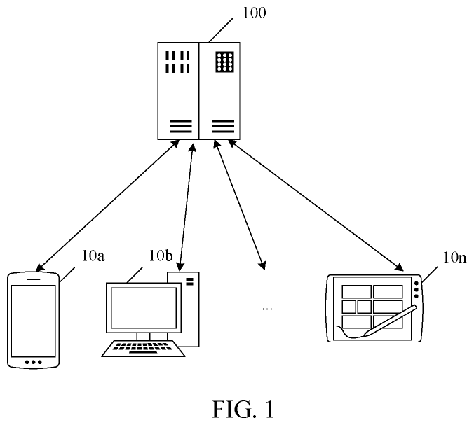

FIG. 1 is a schematic diagram of a network architecture according to an embodiment of this disclosure. As shown in FIG. 1, the network architecture may include a service server 100 and a terminal device cluster. The terminal device cluster may include a terminal device 10a, a terminal device 10b, . . . , and a terminal device 10n. Any terminal device in the terminal device cluster may have a communication connection with the service server 100. For example, the terminal device 10a has a communication connection with the service server 100, and the terminal device 10b has a communication connection with the service server 100. The foregoing communication connection does not limit a connection manner, which may be a direct or indirect connection in a wired communication manner, may be a direct or indirect connection in a wireless communication manner, or may be in another manner. This is not limited in this disclosure herein.

Each terminal device in the terminal device cluster may include: a smart terminal having a data processing function, such as a smart phone, a tablet computer, a notebook computer, a desktop computer, a smart voice interaction device, a smart home appliance (for example, a smart television), a wearable device, an on-board terminal, or an aircraft. The on-board terminal may be a terminal device in a smart traffic scenario or an assisted driving scenario. Each terminal device in the terminal device cluster shown in FIG. 1 may be installed with an application client having a data processing function. When running in each terminal device, the application clients may respectively perform data interaction with the foregoing service server 100 shown in FIG. 1.

The application client may include an on-board client, a smart home client, an entertainment client (for example, a game client), a multimedia client (for example, a video client), a social client, an information client (for example, a news client), or the like. The application client in embodiments of this disclosure may be integrated in a client (for example, the social client), or may be an independent client (for example, the news client). A type of the application client is not limited in embodiments of this disclosure.

The service server 100 may be a server corresponding to the application client. The service server 100 may be an independent physical server, a server cluster composed of multiple physical servers, a distributed system, or a cloud server that provides basic cloud computing services such as a cloud service, a cloud database, cloud computing, a cloud function, cloud storage, a network service, cloud communication, a middleware service a domain name service, a security service, a content delivery network (CDN), big data, and an artificial intelligence platform.

A cloud technology is a hosting technology that unifies a series of resources, such as hardware, software, and a network in a wide area network or a local area network to implement calculation, storage, processing, and sharing of data. The cloud technology is a collective name of a network technology, an information technology, an integration technology, a platform management technology, an application technology, and the like based on application of business models for cloud computing. The technologies may form a resource pool for use on demand, which is flexible and convenient. A cloud computing technology is to become an important support. Backend services of a technology network system require a lot of computing and storage resources, such as a video website, a picture website, and more portal websites. With the rapid development and application of the Internet industry, each item may have its own identification mark in the future, and the identification marks need to be transmitted to a backend system for logical processing. Data of different levels is processed separately, and all kinds of industry data require a strong system support, which can be achieved through the cloud computing.

As shown in FIG. 1, each terminal device in the terminal device cluster may perform data interaction with the service server 100 by using an installed application client. For ease of understanding, the terminal device 10a is used as an example for description. In the terminal device 10a, the object (user) may browse, view, or use media content respectively corresponding to different function components in the application client, and each function component may correspond to a different media data stream. For example, the user may view media content in the first media data stream, the terminal device 10a may send a media content obtaining request for the first media data stream, and the service server 100 sends the media content in the first media data stream to the terminal device 10a. The terminal device 10a displays the media content by using the application client. Equivalent replacements may be made to the description of the terminal device 10a for the terminal device 10b, . . . , and the terminal device 10n, and details are not described herein again. Different terminal devices may correspond to the same or different users.

The media content may be content of multiple media types, such as a video, an audio, an image, a text, and a combination thereof. The media data stream may be a group of successive media content, for example, may be a consumption stream including a type of media content or an immersive stream including a type of media content.

In the terminal device 10a, when an interactive operation of an object on the media content in the first media data stream satisfies a media data stream distribution condition, the application client may display a cross-stream guide card including cover content. The cross-stream guide card may be associated with a second media data stream. The cross-stream guide card may be a user page element in a card form that is configured to allow display and jump of the second media data stream. The cover content may be an image or a video that describes the second media data stream, or may be a video frame or a video clip of the target media content in the second media data stream. Media content in the second media data stream is determined based on historical media content interacted with the object. The data stream distribution condition may refer to a condition that is satisfied when the interactive operation of the object shows no more browsing, watching, or using requirement on the first media data stream, and for example, may be a low viewing duration, a low interaction frequency, or the like.

The object may click the cross-stream guide card, the terminal device 10a may transmit, in response to a trigger operation on the cross-stream guide card, a media content obtaining request for the second media data stream, the service server 100 transmits the media content in the second media data stream to the terminal device 10a, and the terminal device 10a may display the target media content in the second media data stream through the application client. The target media content is associated with the cover content displayed by the cross-stream guide card.

In embodiments of this disclosure, when the interactive operation of the object on the media content in the first media data stream satisfies the media data stream distribution condition, the cross-stream guide card associated with the second media data stream is displayed, thereby satisfying diversified requirements of the object and helping the object to explore and discover another piece of media content different from the current media content. Increasing diversity of media content and providing diversified content may improve a frequency of accessing an application client by an object. The cross-stream guide card includes the cover content, and the cover content is associated with the target media content in the second media data stream. In a more intuitive manner, a user may be allowed to perceive and understand theme information on the media content in the second media data stream, thereby enriching content push manners. A manner of displaying the cross-stream guide card is similar to a manner of displaying media content in a system, which may improve immersion and user experience during watching.

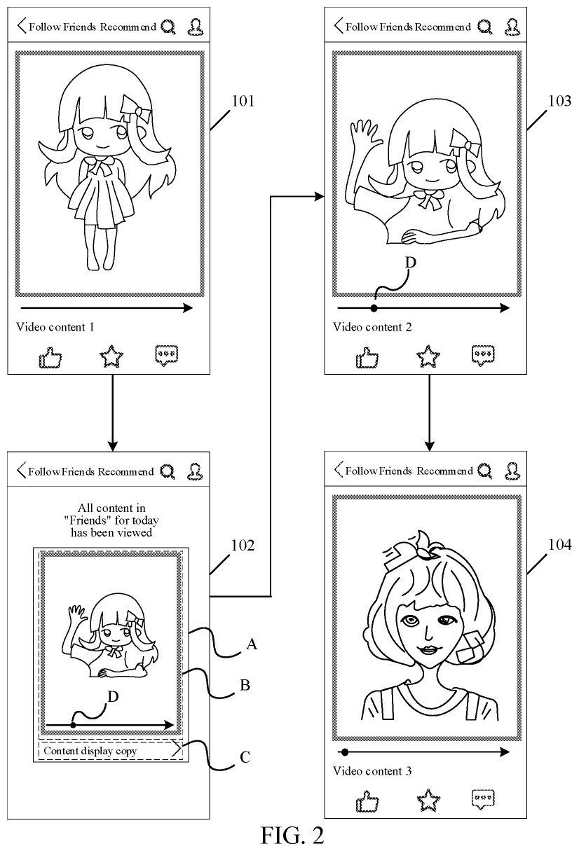

FIG. 2 is a schematic diagram 1 of a data processing scenario according to an embodiment of this disclosure. As shown in FIG. 2, for ease of understanding, an example in which the media content is video content is used for description. In the application client of the terminal device (i.e., the terminal), each function component may correspond to a different video data stream (a media data stream corresponding to the video content). For example, a video data stream corresponding to a friend function component (i.e., a social function component) may be content recommended or liked by a friend added by the object (user) to an account logged into the application client, and a video data stream corresponding to a follow function component may be content published by an account followed by the object in the account logged into the application client.

The terminal device may be any terminal device in the foregoing embodiment corresponding to FIG. 1. The video data stream and the video content may be sent to the terminal device by the service server. The service server may be the service server 100 in the foregoing embodiment corresponding to FIG. 1. The video data stream may be a group of successive video content. The video content in the video data stream has a specific display position order. The video content may be displayed in full screen by covering a display screen of the terminal device with a single piece of content. Alternatively, the corresponding video content may be displayed in a corresponding display region. The display region may be determined based on a size of a display interface occupied by the video content, and may also be set by the user based on an actual use requirement. This is not limited herein.

As shown on a page 101, the object may watch video content 1 in the first video data stream in the friend function component. When playback of the video content 1 is completed, and the video content 1 is last video content in the video data stream corresponding to the friend function component, the terminal device may determine that the interactive operation of the object on the media content in the first media data stream satisfied the media data stream distribution condition, and the terminal device may switch a page used for displaying the video content 1 to a page used for displaying the cross-stream guide card.

The data stream distribution condition may be a condition that is satisfied when the interactive operation by the object shows no more browsing, watching, or using requirement on the first media data stream. For example, the data stream distribution condition may be one or more of a low watching duration of the media content (that is, the watching duration is less than a duration threshold), and a low interaction frequency of the media content (that is, the interaction frequency is less than an interaction frequency threshold).

The cross-stream guide card may also be displayed in a form of a pop-up window or a floating layer, which is not limited herein. The cross-stream guide card may be associated with the second media data stream. The cross-stream guide card may be a user page element that is in a card form and is configured to allow display and jump of another video data stream (including the second media data stream).

In some embodiments, in response to the trigger operation on the first function item, the first function item may be controlled to be in a selected state, and the media content in the first media data stream is displayed. The first function item is used for obtaining the media content in the first media data stream by using the first type of screening.

The first function item may be provided by the application program based on different functions. For example, the first function item may correspond to any one of a friend function component, a follow function component, and a recommendation function component. For another example, the media content exists in a plurality of types. The media content may be classified in advance. The classified media content includes sports, entertainment, weather, and the like. Therefore, the first function item corresponds to any type, which is not limited herein.

In some embodiments, the selected state may be implemented in one or more manners of displaying a text corresponding to the first function item in bold, identifying the first function item by using a highlighted selection mark, and magnifying displaying of the text corresponding to the first function item. The highlighted selection mark may be one or more of a text, an image, or a video, which may be set based on an actual use requirement.

In some embodiments, in response to the trigger operation on the cross-stream guide card, the control of the first function item to be in the selected state is canceled, the second function item is controlled to be in the selected state, and the target media content in the second media data stream is displayed.

The second function item is used for obtaining the media content in the second media data stream by using a second type of screening. The first type is different from the second type. For example, the first function item may correspond to the friend function component, and the second function item may correspond to the recommendation function component. A first type of media content is media content published by an account that has a friendship with an account logged into the application program, and a second type of media content is media content recommended based on media content historically interacted with an account logged into the application program.

For another example, the first function item may correspond to sports, the second function item may correspond to entertainment, the first type of media content is sports-associated media content, and the second type of media content is entertainment-associated media content. In such a manner, a type of displayed media content may be implemented by using one-click switching of the cross-stream guide card, thereby enriching the interaction manners and the displayed content, and improving resource utilization of the electronic device and interactive experience between the user and the media content.

For example, when the object watches the video content in the friend function component, display and jump of the video content in the follow function component may be enabled through the cross-stream guide card. In this case, the video stream data corresponding to the follow function component displayed and redirected by the cross-stream guide card may also be referred to as the second video data stream.

The video content in the video data stream corresponding to the cross-stream guide card may be video content corresponding to a function component, for example, the video content in the follow function component or the video content in the recommendation function component, and may also be specific video content determined in combination with the historical video content interacted with the object, for example, video content corresponding to a specific subject or video content corresponding to a specific keyword. This is not limited in embodiments of this disclosure herein.

As shown on a page 102, the terminal device may display prompt information of “having watched the content in the “friend” today” in the application client, and display the cross-stream guide card A. The cross-stream guide card A may include cover content B and a content display copy C. The cover content B may be an image or a video used for describing the target video content in the second media data stream. The target video content may be video content whose display position is the first in the second video data stream. For example, the cover content B may be a video frame or a video clip of video content 2 of the second video data stream in the follow function component. The content display copy C may be a text describing the second media data stream, for example, may be a title, a brief introduction, or a guiding text of the video content 2. The content display copy C may be “Go to see more “follow” content”.

When the cover content B is a video clip of the video content 2 in the second video data stream, the cover content B may automatically play the video content 2, and record a target playback progress D corresponding to the video content 2. The object may click the cross-stream guide card A, as shown on a page 103, and the terminal device may start to play the video content 2 associated with the cover content B from the target playback progress in response to the trigger operation on the cross-stream guide card A.

As shown on a page 104, the terminal device may display video content 3 in the second media data stream in response to the switching operation on the video content 2. The switching operation may refer to that the object switches the video content or the video content is automatically switched after the playback is completed. The video content 3 may be video content that is in the second video data stream and whose display position is adjacent to the video content 2.

In the data processing method provided in embodiments of this disclosure, a cross-stream guide card is displayed when an interactive operation on media content in a first media data stream satisfies a media data stream distribution condition, so that displayed content can be enriched, thereby improving resource utilization of an electronic device. Target media content in a second media data stream is displayed in response to a trigger operation on the cross-stream guide card, so that interaction manners can be enriched, further enriching the displayed content and further improving resource utilization of an electronic device. In response to a switching operation on target media content, media content in the second media data stream adjacent to the target media content may be displayed, so that the displayed content can be further enriched, thereby further improving resource utilization of the electronic device.

The data processing method provided in embodiments of this disclosure can enrich the displayed content and improve resource utilization of the electronic device. In addition, the cross-stream guide card is associated with the second media data stream, and the user can intuitively learn theme information of the media content in the associated second media data stream by using the cross-stream guide card, thereby enriching content push manners. Through the cross-stream guide card, a jump to the second media data stream manner may be more efficient, and the cross-stream guide card may provide diversified media content to attract an object, thereby improving object stickiness and an exposure rate of media content. The second media data stream includes multiple pieces of media content. Successive media content may provide more consistent watching experience, may improve watching immersion and user experience, and can address the foregoing technical problem 1.

In embodiments of this disclosure, the cross-stream guide card associated with the second media data stream is displayed, so that the cross-stream guide card including cover content can be displayed to an object. The cover content is associated with the target media content in the second media data stream. In a more intuitive manner, the user may perceive and understand the theme information on the media content in the second media data stream, thereby enriching content push manners. When media content is video content, video clips of the target media content may be automatically played through the cover content, thereby providing richer display content, enabling an object to better understand the media content in the second media data stream, and improving attraction of the media content in the second media data stream to the object. A target playback progress is recorded, and media content associated with the cover content is played from the target playback progress, so that more convenient user experience can be provided. To be specific, when browsing media content, a user browses content in different media data streams more conveniently.

Through the cross-stream guide card, watching immersion and user experience may be improved. A user may be allowed to continue watching the media content in the cross-stream guide card in a second media data stream. The second media data stream is a group of successive media content. After it may be enabled to respond to a switching operation on target media content, media content in the second media data stream adjacent to the target media content may be displayed. Media content in the second media data stream may be related to a theme or a series, may enable deeper content discussion to improve participation of an object, make the object watch videos in different fields, and interest of the object in a field may be stimulated, thereby guiding the object to further explore and learn, thereby enhancing object stickiness and an exposure rate of media content. Videos in different fields may attract users having a common interest to gather together to form a community, increasing interaction among users. Users with different interests and backgrounds may be attracted, thereby expanding a user base of a platform. Successive media content may enable more consistent watching experience, may enhance user stickiness and bring better immersive watching experience, and can address the technical problem 2 and the technical problem 3.

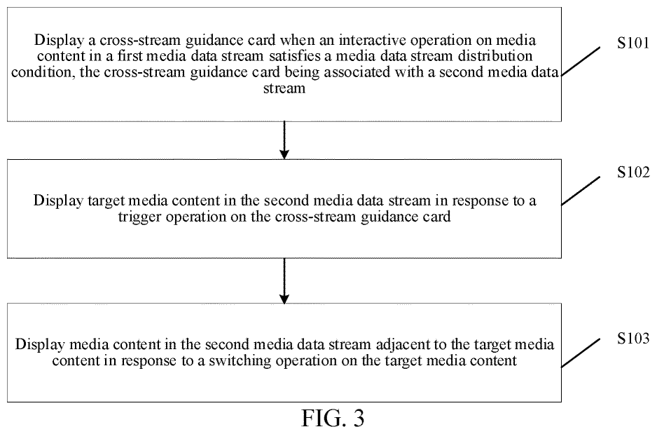

FIG. 3 is a schematic flowchart 1 of a data processing method according to an embodiment of this disclosure. The data processing method may be performed by an electronic device. The electronic device may be any terminal device (for example, the terminal device 10a) in the terminal device cluster shown in FIG. 1 or the service server 100. A description is provided below by using an example in which the data processing method is performed by an electronic device. The data processing method may include at least the following operation S101 to operation S103.

Operation S101: Display a cross-stream guide card when an interactive operation on media content in a first media data stream satisfies a media data stream distribution condition, the cross-stream guide card being associated with a second media data stream.

In an actual application process, an application program may be installed on the terminal. The application program may be one or more of an instant messaging application program, a social information application program, a video application program, a live streaming application program, and an information reading application program. In response to the trigger operation on the application program, the display interface of the application program may be displayed.

In some embodiments, the electronic device may display the media content in the first media data stream in the display interface of the application program, and the object (user) may browse or watch the media content. The media content may be content of multiple media types, such as a video, an audio, an image, a text, and a combination thereof. The media data stream may be a group of successive media content, and the media content in the media data stream has a display position order, for example, may be a consumption stream including a type of media content or an immersive stream including a type of media content.

The consumption stream including the media content refers to a process used for interacting with corresponding media content in the application program. The interaction may be browsing, a like, a comment, or the like. The consumption stream is a dynamic process for the user to successively switch and select different media content based on interests, requirements, and scenarios of the user. The immersive stream including the media content refers to that the user is immersed in one or more media content in a process in which the user interacts with the media content. There may be multiple pieces of media content, and successive media content may provide richer and immersive watching experience for the object, which may improve user stickiness, and bring better immersive watching experience.

When the interactive operation performed by the object on the media content in the first media data stream satisfies the media data stream distribution condition, the electronic device may display the cross-stream guide card. The cross-stream guide card may be associated with a second media data stream. The cross-stream guide card may be a user page element in a card form that is configured to allow display and jump of the second media data stream. The media content in the second media data stream may be determined based on the historical media content interacted with the object. The data stream distribution condition may be a condition that is satisfied when the interactive operation by the object shows no more browsing, watching, or using requirement on the first media data stream. For example, the data stream distribution condition may be one or more of a low watching duration of the media content (that is, the watching duration is less than a duration threshold), and a low interaction frequency of the media content (that is, the interaction frequency is less than an interaction frequency threshold).

The cross-stream guide card is described below. The cross-stream guide card is a user interface (UI) element in a card form for guiding the user to perform interaction between different media information streams, which is configured to improve user experience and prompt the user to switch between the different media information streams. The cross-stream guide card may be an information interface displayed in a manner of a pop-up window or a floating layer, and may carry one or more types of content in a text, an image, and a video. In the data processing method provided in embodiments of this disclosure, the cross-stream guide card is configured to allow a jump to the second media information stream from the first media information stream, so as to implement switching of the displayed media content of the first media information stream to the media content of the second media information stream.

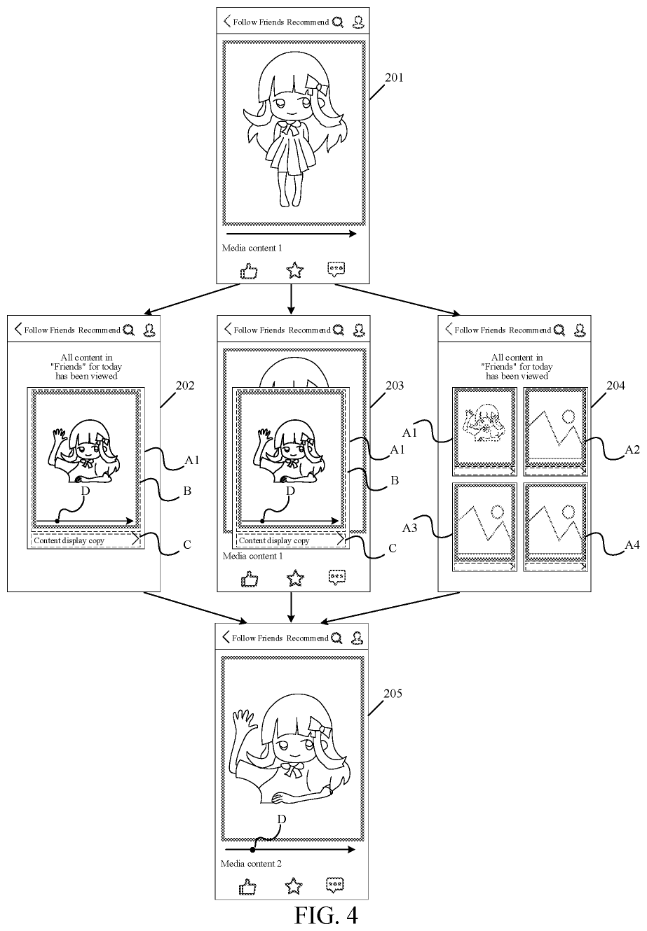

FIG. 4 is a schematic diagram 2 of a data processing scenario according to an embodiment of this disclosure. As shown in FIG. 4, on a page 201, the object may browse or view media content 1 in the first media data stream.

When the electronic device detects that the interactive operation performed by the object on the media content in the first media data stream satisfies the media data stream distribution condition, as shown on a page 202, the electronic device may create a page used for displaying the cross-stream guide card A1, and switch the page 201 used for displaying the media content 1 to the page 202 used for displaying the cross-stream guide card. As shown on a page 203, the electronic device may also directly display the cross-stream guide card A1 on the page 201.

The cross-stream guide card A1 may include the cover content B and the content display copy C. The cover content B may be an image or a media used for describing the target media content in the second media data stream. The target media content may be media content whose display position is the first in the second media data stream. For example, the target media content may be media content 2, and the cover content B may be a media frame or a media clip of the media content 2.

The content display copy C may be a text describing the second media data stream, for example, may be a title, a brief introduction, or a guiding text of the media content 2. In some embodiments, the content display copy C may also be dynamically determined based on the historical media content interacted with the object. This is not limited in embodiments of this disclosure herein.

In some embodiments, as shown on a page 204, the electronic device may display M cross-stream guide cards on the page used for displaying the cross-stream guide card, M being a positive integer. For example, the M cross-stream guide cards may include the cross-stream guide card A1, the cross-stream guide card A2, the cross-stream guide card A3, and the cross-stream guide card A4. The M cross-stream guide cards are respectively associated with different second media data streams, the media content in the M second media data streams is all determined based on the historical media content interacted with the object, and the M cross-stream guide cards may all include respective corresponding cover content and content display copies.

In embodiments of this disclosure, a plurality of cross-stream guide cards are displayed for the object to select, which may provide more diversified selection spaces, improve a click rate of the cross-stream guide cards, and optimize experience of the object, thereby providing a more accurate push service of the second media data stream.

Operation S102: Display the target media content in the second media data stream in response to the trigger operation on the cross-stream guide card.

In some embodiments, as shown in FIG. 4, the object may click the cross-stream guide card A1, and the electronic device may respond to the trigger operation performed by the object on the cross-stream guide card. As shown on the page 204, the electronic device may display target media content (the media content 2 is shown in FIG. 4) in the second media data stream. The target media content is associated with the cover content displayed by the cross-stream guide card.

In some embodiments, when the media content 2 is video content, the cover content B may be a video clip of the media content 2. When a display duration of the cover content C of the cross-stream guide card A1 reaches a display time threshold (a preset value, i.e., a duration threshold), the electronic device may play the media content 2 in the cross-stream guide card A1, and record a target playback progress D corresponding to the media content 2. The target playback progress D may be a playback progress of the target media content in the cross-stream guide card. The object may click the cross-stream guide card A1, as shown on a page 204, and the electronic device may start to play the media content 2 associated with the cover content B from the target playback progress in response to the trigger operation performed by the object on the cross-stream guide card A1.

In some embodiments, the media content in the first media data stream is media content under the first theme. When the interactive operation on the media content in the first media data stream satisfies the media data stream distribution condition, the theme information of at least one second theme is displayed.

In some embodiments, the theme information may be different function items. For example, a plurality of function items in a candidate status may be displayed. In some embodiments, the theme information may be one or more of a text, an image, and a video. Each piece of theme information has a corresponding type. The theme information may also include description information on the type. The first theme may correspond to a type. For example, the first theme may be a text corresponding to any function item, and the first theme may also be any one of sports, entertainment, or weather. This is not limited herein.

In response to the selection instructions on the target theme information in the theme information of the at least one second theme, the cross-stream guide card corresponding to the target theme information is displayed. In some embodiments, in response to a selection operation on a target function item in the plurality of function items in the candidate status, the target function item may be controlled to be in a selected state. In response to determining instructions on the target function item in the selected state, selection instructions may be triggered, and then a cross-stream guide card corresponding to the target function item may be displayed. To be specific, the cross-stream guide card corresponding to the target theme information is displayed.

For example, a friend function item (corresponding to the friend function component) and a follow function item (i.e., the follow function component) may be displayed. In response to a selection operation on the friend function item, the friend function item may be controlled to be in a selected state. In response to determining instructions on the friend function item in the selected state, selection instructions may be triggered, and then a cross-stream guide card corresponding to the friend function item may be displayed. To be specific, the cross-stream guide card corresponding to the target theme information is displayed. In this manner, the user may screen a theme corresponding to the media data stream based on an actual use requirement, and may display a cross-stream guide card that better meets a user interaction requirement, so as to display media content that better meets the user interaction requirement, thereby improving use experience of the user, enriching the displayed content, and improving resource utilization of the electronic device.

In the data processing method provided in embodiments of this disclosure, when the media content is video content, the cover content may automatically play the video clip of the target media content, thereby providing richer display content, improving resource utilization of the electronic device, enabling the object to better understand the media content in the second media data stream, and improving attraction of the media content in the second media data stream to the object. The target playback progress is recorded, and the media content associated with the cover content is played from the target playback progress, which may provide more convenient user experience.

Operation S103: Display media content adjacent to the target media content in the second media data stream in response to a switching operation on the target media content.

In some embodiments, the electronic device may respond to a switching operation on the target media content. Referring to FIG. 4, as shown on a page 205, media content adjacent to the target media content in the second media data stream is displayed. The media content adjacent to the target media content (the media content 1) may be the media content 2, and the switching operation may refer to that the object switches the media content or the media content is automatically switched after the playback is completed.

In some embodiments, when a plurality of cross-stream guide cards are displayed on the page used for displaying the cross-stream guide card, the electronic device may undisplay the target guide card in the displayed M cross-stream guide cards in response to an exit operation performed by the object on the second media data stream associated with the target guide card (the cross-stream guide card A1). To be specific, the cross-stream guide card A2, the cross-stream guide card A3, and the cross-stream guide card A4 continue to be displayed on the page used for displaying the cross-stream guide card.

For example, the target guide card may be the cross-stream guide card A1. The object may click on the cross-stream guide card A1 to browse or watch media content in the second media data stream associated with the cross-stream guide card A1. When the media content in the second media data stream associated with the cross-stream guide card A1 is displayed, the electronic device may switch, in response to a display completion operation of the second media data stream associated with the target guide card, the page used for displaying the media content in the second media data stream to the page used for displaying the cross-stream guide card, and determine the card status of the target guide card as the redirected state.

The electronic device may obtain Q cross-stream guide cards with the card statuses being the non-redirected state in the first media data stream, and display the Q cross-stream guide cards on the page used for displaying the cross-stream guide card, Q being a positive integer less than M. For example, the Q cross-stream guide cards may be the cross-stream guide card A2, the cross-stream guide card A3, and the cross-stream guide card A4.

When a plurality of cross-stream guide cards are displayed, and the object selects a target guide card thereof, and exits the target guide card or completes playback of media content associated with the target guide card, the electronic device may continue to display a cross-stream guide card to which a jump is not performed by a user, which can enrich the displayed content and improve resource utilization of the electronic device, thereby continuing to provide a push service of the second media data stream for the user, helping the object to explore and discover another media content, and increasing diversity of media content.

In embodiments of this disclosure, when the interactive operation performed by the object on the media content in the first media data stream satisfies the media data stream distribution condition, the cross-stream guide card associated with the second media data stream is displayed, so that the cross-stream guide card including the cover content may be displayed to the object. The cover content is associated with the target media content in the second media data stream. In a more intuitive manner, the user may perceive and understand the theme information of the media content in the second media data stream, thereby enriching content push manners. In addition, the media content in the second media data stream is determined based on the historical media content interacted with the object. Therefore, diversified requirements of the object may be satisfied based on the interacted historical media content, and the object may also be helped to explore and discover another piece of media content different from the current media content, thereby increasing diversity of media content. The cross-stream guide card may more efficiently guide the object for a jump to the second media data stream, and the cross-stream guide card may provide diversified media content to attract the object, thereby improving stickiness of the object and an exposure rate of the media content. In addition, a manner of displaying the cross-stream guide card is similar to a manner of displaying media content by a system, which may improve watching immersion and user experience, and may make the user continue to watch the media content in the cross-stream guide card in the second media data stream. The second media data stream is a group of successive media content, and after in response to the switching operation on the target media content, may display media content adjacent to the target media content in the second media data stream. The media content in the second media data stream may surround a theme or a series, which may provide deeper content discussion and improve participation of the object. Successive media content may enable more consistent watching experience, thereby improving immersion of an object in browsing or watching media content.

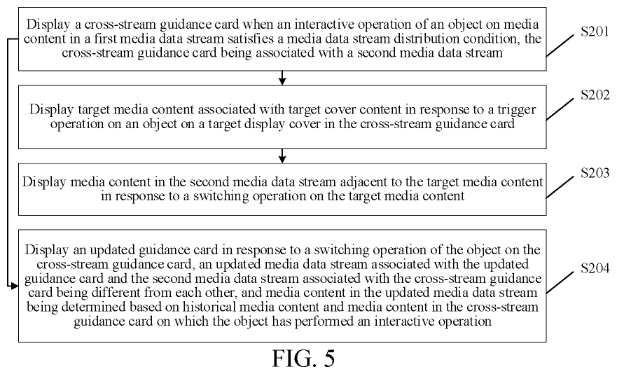

FIG. 5 is a schematic flowchart 2 of a data processing method according to an embodiment of this disclosure. The data processing method may be performed by an electronic device. The electronic device may be any terminal device (for example, the terminal device 10a) in the terminal device cluster shown in FIG. 1 or the service server 100. A description is provided below by using an example in which the data processing method is performed by an electronic device. The data processing method may include at least the following operation S201 to operation S204.

Operation S201: Display the cross-stream guide card when the interactive operation performed by the object on the media content in the first media data stream satisfies the media data stream distribution condition, the cross-stream guide card being associated with the second media data stream.

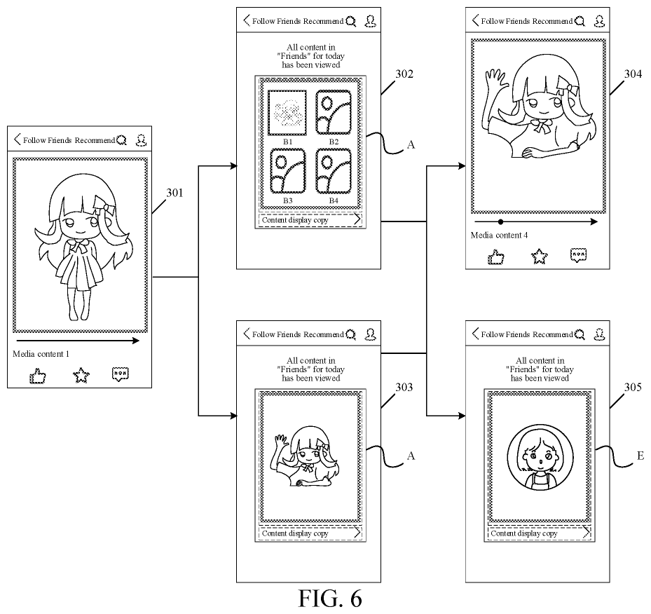

In some embodiments, FIG. 6 is a schematic diagram 3 of a data processing scenario according to an embodiment of this disclosure. As shown in FIG. 6, in the application client of the electronic device, each function component may correspond to a different video data stream. For example, a media data stream corresponding to the friend function component may be content recommended or liked by a friend added by the object (user) in the application client, and a media data stream corresponding to the follow function component may be content published by an account followed by the object in the application client.

For example, the object may browse or watch media content in the first media data stream in the friend function component. The media content may be content of multiple media types, such as a video, an audio, an image, a text, and a combination thereof. The media data stream may be a group of successive media content, and the media content in the media data stream has a display position order, for example, may be a consumption stream including a type of media content or an immersive stream including a type of media content.

Successive media content may provide more abundant and immersive watching experience for the object, which makes the object spend time more easily, increases a residence time of the user on the platform, and improves user stickiness. During immersive watching experience, an advertisement may be more naturally integrated into the media content, thereby improving acceptance and an effect of the advertisement.

The media data stream may include a plurality of data items arranged in sequence, and the plurality of data items include the media content in the first media data stream and the cross-stream guide card. The cross-stream guide card may be a user page element in a card form that is configured to allow display and jump of the second media data stream. The cross-stream guide card may be associated with the second media data stream. The cross-stream guide card may be data pre-placed in the first media data stream based on the historical media content interacted with the object when the application client requests a data item of the first media data stream.

Referring to FIG. 6, as shown on a page 301, the object may watch media content in the first media data stream in the friend function component. When the object clicks on the friend function component, the first media data stream obtained by an electronic device may include [media content 1, media content 2, a cross-stream guide card A, media content 3, . . . ]. The electronic device may traverse in sequence data items in the first media data stream based on a position of currently displayed media content in the first media data stream. For example, the currently displayed media content is the media content 1. When an object switches the media content 1, the electronic device may obtain, through traversal, a next data item of the media content 1 in the first media data stream to display the media content 2.

When the object switches the media content 2, the electronic device may traverse the first media data stream to obtain the cross-stream guide card A. The electronic device may determine that an interactive operation of an object on the media content in the first media data stream satisfies a media data stream distribution condition, and display the cross-stream guide card A in an application client.

In some embodiments, the cross-stream guide card in the first media data stream may also be data dynamically inserted into the first media data stream by the electronic device in combination with the interactive operation of the object for the media content in the first media data stream. For example, when the object clicks on the friend function component, the first media data stream obtained by the electronic device may include [the media content 1, the media content 2, the media content 3, . . . ]. When the object switches the media content 2, the electronic device may determine, in combination with the interactive operation of the object on the media content in the first media data stream, that the interactive operation of the object on the media content in the first media data stream satisfies the media data stream distribution condition, generate, based on the historical media content interacted with the object, media content in the second media data stream associated with the cross-stream guide card A, and display the cross-stream guide card A in the application client.

The media content in the second media data stream associated with the cross-stream guide card A may be determined in advance by the media content in the first media data stream when the object starts to browse or watch, or may be dynamically determined in combination with the interactive operation of the object on the media content in the first media data stream. A process of generating the media content in the second media data stream may include: obtaining historical media content interacted with an object and historical interaction information of the object on the historical media content; performing feature extraction on the historical media content to obtain a historical content feature vector; performing feature extraction on the historical interaction information to obtain a historical interaction feature vector; performing vector concatenation on the historical content feature vector and the historical interaction feature vector to obtain a historical result feature vector; performing feature extraction on to-be-recommended media content in a media content library to obtain a media content feature vector; performing attention processing on the historical result feature vector and the media content feature vector to obtain an attention score corresponding to the to-be-recommended media content; and encapsulating, into the to-be-recommended media content based on the attention score, media content satisfying a recommendation condition as the second media data stream.

In some embodiments, the electronic device may determine the media content interacted with the object as the historical media content before the cross-stream guide card A is generated. The electronic device may obtain the historical media content interacted with the object and the historical interaction information of the object on the historical media content. The historical interaction information may include a watching duration, an interaction status (such as, giving a like, saving, giving a review, or the like), or the like.

The electronic device may perform feature extraction on the historical media content to obtain a historical content feature vector, perform feature extraction on the historical interaction information to obtain a historical interaction feature vector, and perform vector concatenation on the historical content feature vector and the historical interaction feature vector to obtain a historical result feature vector. The electronic device may perform feature extraction on the to-be-recommended media content in the media content library to obtain a media content feature vector. The to-be-recommended media content in the media content library may be media content that is not browsed or watched by the object.

The electronic device or a computer device may perform cross-attention processing on the historical result feature vector and the media content feature vector, perform a point multiplication operation on the historical result feature vector and a query parameter matrix W^{Q} to obtain a query vector Q, perform a point multiplication operation on the media content feature vector and a key parameter matrix W^{K} to obtain a key vector K, and perform a point multiplication operation on the media content feature vector and a value parameter matrix W^{V} to obtain a value vector V. The query parameter matrix W^{Q}, the key parameter matrix W^{K}, and the value parameter matrix W^{V} are all matrices formed by learnable parameters. The computer device may generate the key vector K and the value vector V based on the media content feature vector, and generate an attention score vector Score. A process thereof may be shown in Equation (1):

$$Score = Softmax ( \frac{Q {K}^{T}}{\sqrt{{d}_{k}}} ) V \qquad Equation ( 1 )$$

where Softmax function is a normalization function, K^{T} is transposition of the key vector K, and dk is a dimension of the key vector K. The attention score vector Score includes a score corresponding to each to-be-recommended media content.

The electronic device may encapsulate, into the second media data stream, media content satisfying a recommendation condition in the to-be-recommended media content based on the attention score corresponding to each to-be-recommended media content. The recommendation condition may refer to that the attention score is greater than or equal to a preset value. This is not limited in embodiments of this disclosure herein.

During the display of the media content in the first media data stream, the electronic device may detect the interactive operation of the object on the media content in the first media data stream, determine whether the interactive operation of the object on the media content in the first media data stream satisfies the media data stream distribution condition, and determine that the interactive operation of the object satisfies the media data stream distribution condition when detecting an unviewed behavior or a rapid switching behavior in the process of displaying the media content in the first media data stream, and switch the page 301 to a page configured to display a cross-stream guide card. A rapid switching behavior refers to that an interval duration for a switching operation of an object on the media content in the first media data stream is less than or equal to a switching duration threshold. The unviewed behavior may refer to that a duration in which the object does not gaze at an electronic device is greater than or equal to a specific threshold.

In some embodiments, in response to the switching operation of the object on the media content in the first media data stream and when the to-be-switched media content is the last media content in the first media data stream, for example, the first media data stream may include [the media content 1, the media content 2, and the media content 3]. When the object switches the media content 3, the electronic device may determine that the interactive operation of the object satisfies the media data stream distribution condition, generate, based on the historical media content interacted with the object, media content in the second media data stream associated with the cross-stream guide card, and display the cross-stream guide card in the application client.

For example, data items included in the second media data stream include [media content 4, media content 5, media content 6, and media content 7]. Referring to FIG. 6, a display manner of the cross-stream guide card A may be shown on a page 302 or a page 303. On the page 302, the electronic device may display the cross-stream guide card A including multiple pieces of cover content, and N pieces of cover content may include cover content B1, cover content B2, cover content B3, and cover content B4.

The N pieces of cover content are separately associated with different media content, the media content separately associated with the N pieces of cover content belong to the second media data stream, and the N pieces of cover content include target cover content. The media content 4 is associated with the cover content B1, the media content 5 is associated with the cover content B2, the media content 6 is associated with the cover content B3, and the media content 7 is associated with the cover content B4. For example, the target cover content may be the cover content B1.

On the page 303, the electronic device may display the cross-stream guide card A including cover content. The cover content is associated with the target media content. For descriptions about the target media content, reference may be made to the foregoing descriptions of operation S101 in the embodiment corresponding to FIG. 3. Details are not described herein again in embodiments of this disclosure.

Operation S202: Display the target media content associated with the target cover content in response to the trigger operation of the object for the target cover content in the cross-stream guide card.

In some embodiments, still referring to FIG. 6, as shown on a page 304, the electronic device may display the target media content associated with the target cover content in response to the trigger operation of the object on the target cover content in the cross-stream guide card. After the object selects the cover content B1, the electronic device may display the media content 4 in the second media data stream, and after the media content 4 is displayed, traverse and display the media content 5, the media content 6, and the media content 7.

The multiple pieces of cover content may enable more abundant display of media content in the second media data stream, so that interest of an object in media content may be stimulated, thereby guiding the object to browse or watch the media content in the second media data stream, and improving object stickiness and an exposure rate of media content.

Operation S203: Display media content adjacent to the target media content in the second media data stream in response to a switching operation on the target media content.

In some embodiments, reference may be made to the foregoing description of operation S103 in the embodiment corresponding to FIG. 3. Details are not described herein again in embodiments of this disclosure.

Operation S204: Display an updated guide card in response to a switching operation of an object on the cross-stream guide card. An updated media data stream associated with the updated guide card and a second media data stream associated with the cross-stream guide card are different from each other. Media content in the updated media data stream is determined based on the historical media content interacted with the object and the media content in the cross-stream guide card.

In some embodiments, referring to FIG. 6, as shown on the page 302 or the page 303, the object may slide and switch a cross-stream guide card after the application client displays the cross-stream guide card A. The electronic device may traverse data items in a first media data stream in sequence in response to the switching operation of the object on the cross-stream guide card. If a data item obtained through traversal is an updated guide card, the electronic device may display the updated guide card E, and a display manner for the updated guide card may be shown on a page 305. The updated media data stream associated with the updated guide card and the second media data stream associated with the cross-stream guide card are different from each other, and the media content in the updated media data stream is determined based on the historical media content interacted with the object and the media content in the cross-stream guide card.

In embodiments of this disclosure, after the application client displays the cross-stream guide card, the cross-stream guide card may be slid and switched to display the updated guide card, so that more diversified selection spaces can be provided to optimize experience of an object, thereby providing a more accurate push service for a second media data stream.

In embodiments of this disclosure, when the interactive operation performed by the object on the media content in the first media data stream satisfies the media data stream distribution condition, the cross-stream guide card associated with the second media data stream is displayed, so that the cross-stream guide card including the cover content may be displayed to the object. The cover content is associated with the target media content in the second media data stream. In a more intuitive manner, the user may perceive and understand the theme information of the media content in the second media data stream, thereby enriching content push manners. In addition, the media content in the second media data stream is determined based on the historical media content interacted with the object. Therefore, diversified requirements of the object may be satisfied based on the interacted historical media content, and the object may also be helped to explore and discover another piece of media content different from the current media content, thereby increasing diversity of media content. Through a cross-stream guide card, an object may be more efficiently guided for a jump to a second media data stream. Each cross-stream guide card may be associated with different media data streams, and diversified media content may be provided to attract the object, thereby improving object stickiness and an exposure rate of media content. In addition, a manner of displaying the cross-stream guide card is similar to a manner of displaying media content by a system, which may improve watching immersion and user experience, and may make a user continue watching media content in the cross-stream guide card in the second media data stream. The second media data stream is a group of successive media content. After it may be enabled to respond to a switching operation for target media content, media content in the second media data stream adjacent to target media content may be displayed. Media content in the second media data stream may be related to a theme or a series, which may enable deeper content discussion to improve participation of an object. Successive media content may enable more consistent watching experience, thereby improving immersion of an object in browsing or watching media content.

In another aspect, a plurality of cross-stream guide cards are displayed for an object to select, so that more diversified selection spaces may be provided, thereby improving a click rate of a cross-stream guide card and optimizing experience of the object, so as to provide a more accurate push service for a second media data stream. Upon displaying of multiple cross-stream guide cards, when an object selects a target guide card therein and exits the target guide card or completes playback of media content associated with the target guide card, an electronic device may continue displaying a cross-stream guide card to which a jump is not performed by the user, thereby continuing providing a push service of the second media data stream for the user, helping the object to explore and discover another media content and increasing diversity of media content.

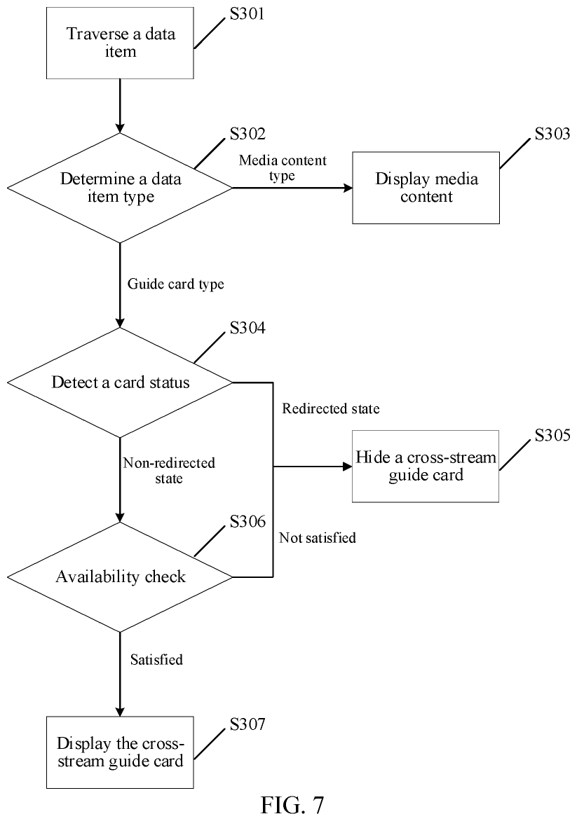

FIG. 7 is a schematic flowchart 3 of a data processing method according to an embodiment of this disclosure. The data processing method may be performed by an electronic device. The electronic device may be any one terminal device (for example, the terminal device 10a) in the terminal device cluster shown in FIG. 1 or the service server 100. A description is provided below by using an example in which the data processing method is performed by an electronic device. The data processing method may include at least the following operation S301 to operation S307.

Operation S301: Traverse data items.

In some embodiments, in an application client of an electronic device, each function component may correspond to a different video data stream. For example, a media data stream corresponding to a friend function component may be content recommended or liked by a friend added by an object (a user) in the application client, and a media data stream corresponding to a follow function component may be content published by an account followed by the object in the application client.

For example, the object may browse or watch media content in the first media data stream in the friend function component. The media content may be content of multiple media types, such as a video, an audio, an image, a text, and a combination thereof. The media data stream may be a group of successive media content, and the media content in the media data stream has a display position order, for example, may be a consumption stream including a type of media content or an immersive stream including a type of media content.

The media data stream may include a plurality of data items arranged in sequence, and the plurality of data items include the media content in the first media data stream and the cross-stream guide card. The cross-stream guide card may be a user page element in a card form that is configured to allow display and jump of the second media data stream. The cross-stream guide card may be associated with the second media data stream. The cross-stream guide card may be data pre-placed in the first media data stream based on historical media content interacted with an object when an application client requests a data item of the first media data stream.

For example, when the object clicks on the friend function component, the first media data stream obtained by the electronic device may include [the media content 1, the media content 2, the cross-stream guide card 1, the media content 3, . . . ]. The electronic device may traverse data items in the first media data stream in sequence based on a position of currently displayed media content in the first media data stream in response to an interactive operation of the object on the media content in the first media data stream. For example, the currently displayed media content is the media content 1, and when the object switches the media content 1, the electronic device may obtain, traversing, a next data item of the media content 1 in the first media data stream to obtain the media content 2.

Operation S302: Determine a data item type.

Operation S303: Display media content.

In some embodiments, the electronic device may determine a data item type of a data item obtained through traversal. If the data item obtained through traversal is media content, the electronic device may switch currently displayed media content and display the media content obtained through traversal. For example, the electronic device may obtain, through traversal, a next data item of the media content 1 in the first media data stream to obtain media content 2, and switch currently displayed media content 1 to the media content 2.

Operation S304: Detect a card status.

In some embodiments, if the data item obtained through traversal is a cross-stream guide card, the electronic device may detect a card status of a traversed cross-stream guide card. For example, the currently displayed media content is the media content 2. When the object switches the media content 2, the electronic device may obtain, through traversal, a next data item of the media content 2 in the first media data stream to obtain a cross-stream guide card 1. The electronic device may detect a card status of the cross-stream guide card 1.

Operation S305: Hide a cross-stream guide card.

In some embodiments, the electronic device may determine a card status of a cross-stream guide card triggered by an object as a redirected state, or may determine a cross-stream guide card clicked or switched by the object as the redirected state after the electronic device displays a cross-stream guide card.

If the card status of the traversed cross-stream guide card is the redirected state, the electronic device may shield (or hide) the traversed cross-stream guide card, and still obtain a next data item through traversal. For example, currently displayed media content is the media content 2. After obtaining the cross-stream guide card 1 through traversal, the electronic device detects that the card status of the cross-stream guide card 1 is the redirected state, and then the electronic device may shield (or hide) the cross-stream guide card 1, and obtain, through traversal, a data item next to the cross-stream guide card 1 in the first media data stream.

Operation S306: Perform an availability check.

Operation S307: Display a cross-stream guide card.

In some embodiments, if the next data item obtained through traversal is a cross-stream guide card whose card status is a non-redirected state, the electronic device may perform the availability check on media content in a second media stream data associated with the cross-stream guide card. For example, after obtaining the cross-stream guide card 1 through traversal, the electronic device detects that the card status of the cross-stream guide card 1 is the non-redirected state, and then the electronic device may perform the availability check on the media content in the second media stream data associated with the cross-stream guide card 1. Data items included in the second media stream data may be [the media content 4, the media content 5, the media content 6, . . . ].

The electronic device may determine, based on media identifiers in the second media data stream, media content that does not exist in a media content library or whose data state in the media content library is an invalid state as media content that fails to pass the availability check. The invalid state may include prohibition of a content, expiration of a content, removal of a content, or the like.

If media content (media content in the second media stream data associated with the cross-stream guide card) in a traversed cross-stream guide card all fails to pass the availability check, the traversed cross-stream guide card is shielded, and a next data item is still traversed. For example, currently displayed media content is media content 2. After obtaining a cross-stream guide card 1 through traversal, the electronic device detects that the card status of the cross-stream guide card 1 is a non-redirected state, but media content in a second media stream data associated with the cross-stream guide card 1 are all invalid states, and then the electronic device may shield (or hide) the cross-stream guide card 1, and obtain, through traversal, a next data item of the cross-stream guide card 1 in the first media data stream.

The data item of the second media data stream may include target media content, and the target media content is associated with cover content of a cross-stream guide card. For example, media content 3 may be the target media content, and the cover content may be a media frame or a media clip of the media content 3. When the electronic device performs the availability check on the media content 3, if it is detected that the cover content in the cross-stream guide card satisfies a content availability condition, the cross-stream guide card including the cover content is displayed.

If it is detected that the cover content in the cross-stream guide card does not satisfy the content availability condition, a media identifier corresponding to the cover content is obtained, media content that is adjacent to a position of the media identifier and that satisfies the content availability condition is determined as new target media content in the second media data stream, new cover content is generated based on the new target media content, and a cross-stream guide card including the new cover content is displayed.

For example, when the electronic device performs the availability check on the media content 3, if it is detected that the media content 3 is in the invalid state, the electronic device may determine the media content 4 adjacent to the media content 3 and satisfying the content availability condition as a new target media content, generate a new cover content based on the new target media content, and display an inclusion of the new cover content.

In some embodiments, the electronic device may simultaneously display a plurality of cross-stream guide cards. When the plurality of cross-stream guide cards are displayed, the electronic device may traverse in sequence and obtain a plurality of data items in the first media data stream. When obtaining a cross-stream guide card through traversal, the electronic device may determine that an interactive operation of an object on media content in a first media data stream satisfies a media data stream distribution condition, perform a card status check and an availability check on all the cross-stream guide cards obtained through traversal, and display cross-stream guide cards that satisfy a non-redirected state and pass the availability check.

The electronic device may display M cross-stream guide cards on a page configured to display a cross-stream guide card, M being a positive integer. For example, the M cross-stream guide cards may include a cross-stream guide card A1, a cross-stream guide card A2, a cross-stream guide card A3, and a cross-stream guide card A4. The M cross-stream guide cards are respectively associated with different second media data streams. Media content in the M second media data streams is all determined based on historical media content interacted with an object, and the M cross-stream guide cards may each include a respective corresponding cover content and a content display copy. For example, the target guide card may be the cross-stream guide card A1. The object may click on the cross-stream guide card A1 to browse or watch media content in the second media data stream associated with the cross-stream guide card A1. When the media content in the second media data stream associated with the cross-stream guide card A1 is displayed, the electronic device may switch, in response to a display completion operation on the second media data stream associated with the target guide card, a page configured to display the media content in the second media data stream to a page configured to display the cross-stream guide card, and determine the card status of the target guide card as a redirected state.

The electronic device may obtain Q cross-stream guide cards with the card statuses being the non-redirected state in the first media data stream, and display the Q cross-stream guide cards on the page used for displaying the cross-stream guide card, Q being a positive integer less than M. For example, the Q cross-stream guide cards may be the cross-stream guide card A2, the cross-stream guide card A3, and the cross-stream guide card A4.

In embodiments of this disclosure, media data streams are traversed in sequence and are displayed based on data item types of data items, and an availability check is performed on a card status of a cross-stream guide card and media content of a second media data stream associated with the cross-stream guide card, so that accuracy and correlation of displaying the cross-stream guide card can be improved, thereby optimizing experience of an object, providing more diversified selection spaces for the object, providing a push service for the second media data stream for a user, helping the object to explore and discover another media content, and increasing diversity of media content. The media content in the second media data stream may be related to a theme or a series, so that deeper content discussion may be provided to improve participation of an object. Successive media content may enable more consistent watching experience, thereby improving immersion of an object in browsing or watching media content. Successive media content may provide richer and immersive watching experience for an object, thereby improving user experience.

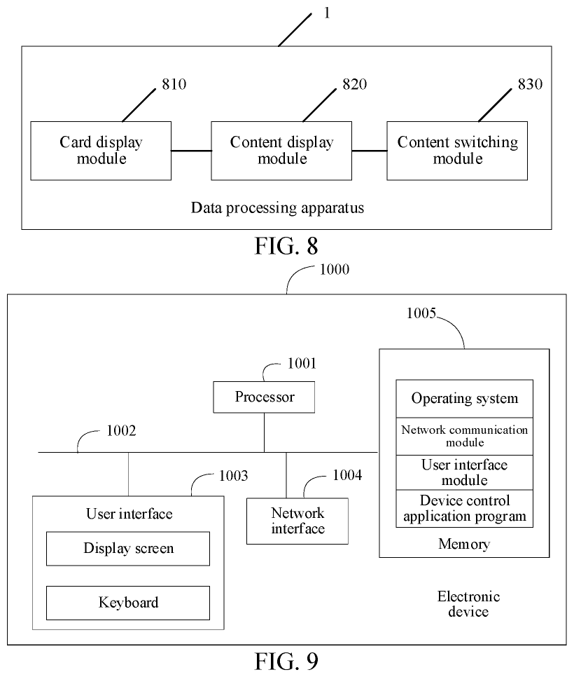

FIG. 8 is a schematic structural diagram of a data processing apparatus according to an embodiment of this disclosure. As shown in FIG. 8, the data processing apparatus 1 includes a card display module 810, a content display module 820, and a content switching module 830.

The card display module 810 is configured to display a cross-stream guide card when an interactive operation on media content in a first media data stream satisfies a media data stream distribution condition, the cross-stream guide card being associated with a second media data stream; the content display module 820 is configured to display target media content in the second media data stream in response to a trigger operation on the cross-stream guide card; and the content switching module 830 is configured to display media content in the second media data stream adjacent to the target media content in response to a switching operation on the target media content.

In an implementation example, a quantity of the cross-stream guide cards is M, M being a positive integer. The card display module 810 is further configured to perform, when the cross-stream guide cards are displayed and the interactive operation on the media content in the first media data stream satisfies the media data stream distribution condition, the following operations: displaying M cross-stream guide cards when the interactive operation on the media content in the first media data stream satisfies the media data stream distribution condition, the M cross-stream guide cards being respectively associated with different second media data streams, the media content in the M second media data streams being all determined based on the historical media content interacted with the object.

The content display module 820 is further configured to perform, when the target media content in the second media data stream is displayed in response to the trigger operation on the cross-stream guide card, the following operations: displaying the target media content in the second media data stream associated with the target guide card in response to the trigger operation on the target guide card, the M cross-stream guide cards including the target guide card.

In an implementation example, the content display module 820 is further configured to perform the following operations: undisplaying the target guide card in the M displayed cross-stream guide cards in response to the exit operation on the second media data stream associated with the target guide card.

In an implementation example, the card display module 810 is further configured to perform the following operations: playing the target media content in the second media data stream in the cross-stream guide card when the display duration of the cover content of the cross-stream guide card reaches the display time threshold, the cover content being the video frame image in the target media content.

The displaying target media content in the second media data stream in response to a trigger operation on the cross-stream guide card includes: switching a page used for displaying the cross-stream guide card to a page used for displaying the target media content in the second media data stream in response to the trigger operation on the cross-stream guide card, and starting to play the target media content in the second media data stream from a target playback progress, the target playback progress referring to a playback progress of the target media content in the cross-stream guide card.

In an implementation example, the cross-stream guide card includes N cover content, N being a positive integer, the N cover content being respectively associated with different media content, the media content respectively associated with the N cover content belonging to the second media data stream, the N cover content including the target cover content. The content display module 820 is further configured to perform, when the target media content in the second media data stream is displayed in response to the trigger operation performed by the object on the cross-stream guide card, the following operations: displaying the target media content associated with the target cover content in response to the trigger operation on the target cover content in the cross-stream guide card.

In an implementation example, the cross-stream guide card further includes the content display copy, and the content display copy is determined based on the historical media content interacted with the object and the media content in the second media data stream.

In an implementation example, the card display module 810 is further configured to perform the following operations: displaying the updated guide card in response to the switching operation on the cross-stream guide card, the updated media data stream associated with the updated guide card and the second media data stream associated with the cross-stream guide card being different from each other, the media content in the updated media data stream being determined based on the historical media content interacted with the object and the media content in the cross-stream guide card.

In an implementation example, the card display module 810 is further configured to perform the following operations: determining, when the to-be-switched media content is the last media content in the first media data stream in response to the switching operation on the media content in the first media data stream, that the interactive operation performed by the object satisfies the media data stream distribution condition.

The card display module 810 is further configured to perform, when the cross-stream guide card is displayed and the interactive operation performed by the object on the media content in the first media data stream satisfies the media data stream distribution condition, the following operations: creating, when the interactive operation performed by the object on the media content in the first media data stream satisfies the media data stream distribution condition in response to the switching operation on the media content in the first media data stream, a card display page, and displaying the cross-stream guide card on the card display page.

In an implementation example, the card display module 810 is further configured to perform the following operations: determining that the interactive operation performed by the object satisfies the media data stream distribution condition when it is detected that an unviewed behavior or a rapid switching behavior exists in the process of displaying the media content in the first media data stream. The rapid switching behavior refers to that the interval duration of the switching operation performed by the object on the media content in the first media data stream is less than or equal to the switching duration threshold.

The card display module 810 is further configured to perform, when the cross-stream guide card is displayed and the interactive operation performed by the object on the media content in the first media data stream satisfies the media data stream distribution condition, the following operations: displaying, when the interactive operation performed by the object on the media content in the first media data stream satisfies the media data stream distribution condition, the cross-stream guide card on the page used for displaying the media content in the first media data stream.

In an implementation example, the card display module 810 is further configured to perform the following operations: obtaining historical media content interacted with an object and historical interaction information of the object on the historical media content, performing feature extraction on the historical media content to obtain a historical content feature vector, and performing feature extraction on the historical interaction information to obtain a historical interaction feature vector; performing vector concatenation on the historical content feature vector and the historical interaction feature vector to obtain a historical result feature vector, and performing feature extraction on to-be-recommended media content in a media content library to obtain a media content feature vector; and performing attention processing on the historical result feature vector and the media content feature vector to obtain an attention score corresponding to the to-be-recommended media content, and encapsulating, into the to-be-recommended media content based on the attention score, media content satisfying a recommendation condition as the second media data stream.

In an implementation example, the first media data stream includes a plurality of data items arranged in sequence, and the plurality of data items include the media content in the first media data stream and the cross-stream guide card. The card display module 810 is further configured to perform the following operations: traversing, in response to the interactive operation on the media content in the first media data stream, the data items in the first media data stream in sequence based on a position of currently displayed media content in the first media data stream; and switching, if a data item obtained through traversal is media content, the currently displayed media content to the media content obtained through traversal.

The card display module 810 is further configured to perform, when the cross-stream guide card is displayed and the interactive operation performed by the object on the media content in the first media data stream satisfies the media data stream distribution condition, the following operations: determining that the interactive operation of the object on the media content in the first media data stream satisfies the media data stream distribution condition if a data item obtained through traversal is a cross-stream guide card, and displaying the cross-stream guide card.

In an implementation example, at least two cross-stream guide cards are provided. The card display module 810 is further configured to perform the following operations: determining a card status of a cross-stream guide card triggered by an object as a redirected state.

The card display module 810 is further configured to perform, when a cross-stream guide card is displayed as an interactive operation of an object on media content in a first media data stream is determined to satisfy a media data stream distribution condition if a data item obtained through traversal is a cross-stream guide card, the following operations: detecting card statuses of traversed cross-stream guide cards if the data item obtained through traversal is the cross-stream guide card; shielding the traversed cross-stream guide cards, and still traversing a next data item if the card statuses of the traversed cross-stream guide cards are the redirected state; and determining that the interactive operation of the object on the media content in the first media data stream satisfies the media data stream distribution condition if a next traversed data item is a cross-stream guide card with a card status being a non-redirected state, and displaying the traversed cross-stream guide card with the card status being the non-redirected state.

In an implementation example, the card display module 810 is further configured to perform, when a cross-stream guide card is displayed as an interactive operation of an object on media content in a first media data stream is determined to satisfy a media data stream distribution condition if a data item obtained through traversal is a cross-stream guide card, the following operations: performing, if the data item obtained through traversal is a cross-stream guide card and the card status of the traversed cross-stream guide card is a non-redirected state, an availability check on media content in the traversed cross-stream guide card; shielding the traversed cross-stream guide card and still traversing a next data item if the media content in the traversed cross-stream guide card fails the availability check; and determining that the interactive operation of the object on the media content in the first media data stream satisfies the media data stream distribution condition if the next traversed data item is a cross-stream guide card having a card status as the non-redirected state and passing an availability check, and displaying the traversed cross-stream guide cards having the card statuses as the non-redirected state and passing the availability check.

In an implementation example, the card display module 810 is further configured to perform, when the cross-stream guide card is displayed as the interactive operation of the object on the media content in the first media data stream satisfies the media data stream distribution condition, the following operations: performing a media content availability check on cover content in the cross-stream guide card when the interactive operation of the object on the media content in the first media data stream satisfies the media data stream distribution condition; displaying the cross-stream guide card including the cover content if it is detected that the cover content in the cross-stream guide card satisfies the content availability condition; and obtaining a media identifier corresponding to the cover content, determining media content that is adjacent to a position of the media identifier and that satisfies the content availability condition as new target media content in the second media data stream, generating new cover content based on the new target media content, and displaying an inclusion of the new cover content, if it is detected that the cover content in the cross-stream guide card does not satisfy the content availability condition.

In an implementation example, the card display module 810 is further configured to perform the following operations: determining that cover content in a cross-stream guide card does not satisfy a content availability condition if target media content indicated by the cover content in the cross-stream guide card does not exist in a media content library or a data state of the target media content in the media content library is an invalid state.

In an implementation example, the card display module 810 is further configured to perform the following operations: switching, in response to a display completion operation on a second media data stream associated with a target guide card, a page configured to display media content in the second media data stream to display a page configured to display a cross-stream guide card, and determining a card status of the target guide card as a redirected state; and obtaining Q cross-stream guide cards with card statuses as a non-redirected state in a first media data stream, and displaying the Q cross-stream guide cards on the page configured to display the cross-stream guide card, Q being a positive integer less than M.

In some embodiments, the card display module 810 is further configured to control, in response to a trigger operation on a first function item, the first function item to be in a selected state, and displaying the media content in the first media data stream, where the first function item is configured to obtain the media content in the first media data stream through screening through a first type.

The content switching module 830 is further configured to cancel, in response to a trigger operation on a cross-stream guide card, the control of the first function item to be in the selected state, control a second function item to be in a selected state and display target media content in the second media data stream, where the second function item is configured to obtain the media content in the second media data stream through screening through a second type.

In some embodiments, the media content in the first media data stream is media content under a first theme.

The card display module 810 is further configured to display theme information of at least one second theme when an interactive operation on media content in a first media data stream satisfies a media data stream distribution condition; and display, in response to a selection instruction on target theme information in the theme information of the at least one second theme, a cross-stream guide card corresponding to the target theme information.

In embodiments of this disclosure, when the interactive operation performed by the object on the media content in the first media data stream satisfies the media data stream distribution condition, the cross-stream guide card associated with the second media data stream is displayed, so that the cross-stream guide card including the cover content may be displayed to the object. The cover content is associated with the target media content in the second media data stream. In a more intuitive manner, the user may perceive and understand the theme information of the media content in the second media data stream, thereby enriching content push manners. In addition, the media content in the second media data stream is determined based on the historical media content interacted with the object. Therefore, diversified requirements of the object may be satisfied based on the interacted historical media content, and the object may also be helped to explore and discover another piece of media content different from the current media content, thereby increasing diversity of media content. Through a cross-stream guide card, an object may be more efficiently guided for a jump to a second media data stream. Each cross-stream guide card may be associated with different media data streams, and diversified media content may be provided to attract the object, thereby improving object stickiness and an exposure rate of media content. In addition, a manner of displaying the cross-stream guide card is similar to a manner of displaying media content by a system, which may improve watching immersion and user experience, and may make a user continue watching media content in the cross-stream guide card in the second media data stream. The second media data stream is a group of successive media content. After it may be enabled to respond to a switching operation for target media content, media content in the second media data stream adjacent to target media content may be displayed. Media content in the second media data stream may be related to a theme or a series, which may enable deeper content discussion to improve participation of an object. Successive media content may enable more consistent watching experience, thereby improving immersion of an object in browsing or watching media content.

In another aspect, a plurality of cross-stream guide cards are displayed for an object to select, so that more diversified selection spaces may be provided, thereby improving a click rate of a cross-stream guide card and optimizing experience of the object, so as to provide a more accurate push service for a second media data stream. Upon displaying of multiple cross-stream guide cards, when an object selects a target guide card therein and exits the target guide card or completes playback of media content associated with the target guide card, an electronic device may continue displaying a cross-stream guide card to which a jump is not performed by the user, thereby continuing providing a push service of the second media data stream for the user, helping the object to explore and discover another media content and increasing diversity of media content.

In embodiments of this disclosure, a term “module” or “unit” refers to a computer program or a part of the computer program that has a predetermined function and operates together with another relevant part to achieve a predetermined goal, and may be entirely or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

FIG. 9 is a schematic structural diagram of an electronic device according to an embodiment of this disclosure. As shown in FIG. 9, the electronic device 1000 may include a processor 1001, a network interface 1004, and a memory 1005. In addition, the foregoing electronic device 1000 may further include a user interface 1003 and at least one communication bus 1002. The communication bus 1002 is configured to implement connection and communication between these components. The user interface 1003 may include a display and a keyboard. In some embodiments, the user interface 1003 may further include a standard wired interface and a standard wireless interface. In some embodiments, the network interface 1004 may include a standard wired interface and a standard wireless interface (such as a Wi-Fi interface). The memory 1005 may be a high-speed random access memory (RAM), or may be a non-volatile memory, for example, at least one magnetic disk memory. In some embodiments, the memory 1005 may further be at least one storage apparatus away from the foregoing processor 1001. As shown in FIG. 9, the memory 1005, as a computer-readable storage medium, may include an operating system, a network communication module, a user interface module, and a device control application program.

In the electronic device 1000 shown in FIG. 9, the network interface 1004 may provide a network communication network element. The user interface 1003 is configured to provide an input interface for the user. The processor 1001 may be configured to invoke the device control application program stored in the memory 1005, to implement the following operations: displaying the cross-stream guide card when the interactive operation performed by the object on the media content in the first media data stream satisfies the media data stream distribution condition, the cross-stream guide card being associated with the second media data stream, the media content in the second media data stream being determined based on the historical media content interacted with the object; displaying the target media content in the second media data stream in response to the trigger operation on the cross-stream guide card, the target media content being associated with the cover content displayed by the cross-stream guide card; and displaying media content in the second media data stream adjacent to the target media content in response to a switching operation on the target media content.

The electronic device 1000 described in embodiments of this disclosure may perform the foregoing description of the data processing method in the embodiment corresponding to any one of FIG. 3, FIG. 5, and FIG. 7. Details are not described herein again. In addition, for the description of the beneficial effects of using the same method, details are not described again.

In addition, embodiments of this disclosure further provide a computer-readable storage medium. The foregoing computer-readable storage medium stores a computer program. When executing the foregoing computer program, the foregoing processor can perform the foregoing description of the data processing method in the embodiment corresponding to any one of FIG. 3, FIG. 5, and FIG. 7. Therefore, details are not described herein again. In addition, for the description of the beneficial effects of using the same method, details are not described again. For technical details that are not disclosed in the embodiment of the computer-readable storage medium involved in this disclosure, reference is made to the description of the method embodiment of this disclosure.

The foregoing computer-readable storage medium may be a data processing apparatus provided in any one of the foregoing embodiments or an internal storage unit of the foregoing electronic device, such as a hard disk or a memory of the electronic device. The computer-readable storage medium may also be an external storage device of the electronic device, for example, a plug-in hard disk, a smart media card (SMC), a secure digital (SD) card, or a flash card equipped on the electronic device. Further, the computer-readable storage medium may further include both an internal storage unit and an external storage device of the electronic device. The computer-readable storage medium is configured to store the computer program, and another program and data required by the electronic device. The computer-readable storage medium may also be configured to temporarily store data that has been displayed or that is to be displayed.

In addition, embodiments of this disclosure further provide a computer program product, including a computer program, the computer program being stored in a computer-readable storage medium. A processor of an electronic device reads the computer program from the computer-readable storage medium. The processor executes the computer program, causing the electronic device to perform the foregoing method provided in the embodiment corresponding to any one of FIG. 3, FIG. 5, and FIG. 7.

The terms “first”, “second”, and the like in the specification, the claims, and the drawings of embodiments of this disclosure are configured to distinguish different objects, rather than being configured to describe a specific order. Moreover, the term “include” and any variation thereof are intended to cover non-exclusive inclusions. For example, a process, a method, an apparatus, a product, or a device including a series of operations or units is not limited to the listed operations or modules, but instead, includes operations or modules not listed, or further includes another operation or unit inherent to the process, method, apparatus, product, or device.

A person of ordinary skill in the art may realize that operations of units and algorithms of various examples described with reference to embodiments disclosed in this specification can be implemented in electronic hardware, computer software, or a combination of the electronic hardware and the computer software. To describe interchangeability of hardware and software, the compositions and operations of the various examples are generally described in terms of the network element in the foregoing description. Whether the network elements are performed by hardware or software depends on specific applications and design constraints of the technical solutions. Different methods may be used to implement the described network element for each application, but it is not considered that the implementation goes beyond the scope of this disclosure.

The method and the related apparatus provided in embodiments of this disclosure are described with reference to the method flowcharts and/or schematic structural diagrams provided in embodiments of this disclosure. Each process and/or block in the method flowcharts and/or schematic structural diagrams and a combination of processes and/or blocks in the flowcharts and/or block diagrams may be implemented through computer program instructions. These computer program instructions may be provided to a processor of a general-purpose computer, a special-purpose computer, an embedded processing machine, or another programmable device to generate a machine, so that instructions executed by the processor of the computer or the another programmable device generate an apparatus for implementing functions specified in one or more processes of the flowcharts and/or one or more blocks of the schematic structural diagrams. These computer program instructions may also be stored in a computer-readable memory that can direct a computer or another programmable device to operate in a specific manner, so that the instructions stored in the computer-readable memory produce a product including an instruction apparatus. The instruction apparatus implements the functions specified in one or more processes of the flowchart and/or one or more blocks of the schematic structural diagram. These computer program instructions may also be loaded onto a computer or another programmable device, so that a series of operations are performed on the computer or the another programmable device to generate a computer-implemented process, and the instructions executed on the computer or the another programmable device provide operations for implementing the functions specified in one or more processes of the flowchart and/or one or more blocks of the schematic structural diagram.

The operations of the method of embodiments of this disclosure may be reordered, merged, and deleted based on actual requirements.

The modules of the apparatus of embodiments of this disclosure may be merged, divided, and deleted based on an actual requirement.

What is disclosed above is examples of embodiments of this disclosure, and is not intended to limit the scope of the claims of this disclosure. Therefore, equivalent variations made in accordance with the claims of this disclosure still fall within the scope of this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is disclosed above is examples of embodiments of this disclosure, and is not intended to limit the scope of the claims of this disclosure. Therefore, equivalent variations made in accordance with the claims of this disclosure still fall within the scope of this disclosure.

What is claimed is:

1. A method for data processing, the method comprising:
displaying a cross-stream guide card of a plurality of cross-stream guide cards in a first media data stream when an interactive operation performed by a user on the first media data stream satisfies a media data stream distribution condition, the cross-stream guide card being associated with a second media data stream of a plurality of second media data streams, the media data stream distribution condition indicating whether a watching duration or an interaction frequency associated with the interactive operation of the user meets a threshold value;
displaying target media content in the second media data stream when a trigger operation is performed by the user on the cross-stream guide card, the target media content including cover content of the cross-stream guide card; and
displaying media content in the second media data stream and the target media content when a switching operation is performed by the user on the target media content.

2. The method according to claim 1, wherein:
a quantity of the plurality of cross-stream guide cards is M, M being a positive integer;
the displaying the cross-stream guide card comprises:
displaying the M cross-stream guide cards when the interactive operation performed on the first media data stream satisfies the media data stream distribution condition, each of the M cross-stream guide cards being associated with a respective one of the plurality of second media data streams; and
the displaying the target media content in the second media data stream comprises:
displaying, when the trigger operation is performed on a target guide card that is selected from one of the M cross-stream guide cards, the target media content in the second media data stream associated with the target guide card.

3. The method according to claim 2, further comprising:
stopping the display of the target guide card in the M displayed cross-stream guide cards when an exit operation is performed on the second media data stream associated with the target guide card.

4. The method according to claim 1, wherein the media content includes video content, and the method further comprises:
displaying, in the cross-stream guide card, the target media content in the second media data stream when a display duration of the cover content of the cross-stream guide card reaches a display time threshold, the cover content including a video frame image in the target media content; and
the displaying the target media content in the second media data stream when the trigger operation is performed on the cross-stream guide card comprises:
switching, when the trigger operation is performed on the cross-stream guide card, a page displaying the cross-stream guide card to a page displaying the target media content in the second media data stream; and
displaying the target media content in the second media data stream starting from a target playback progress, the target playback progress indicating a progress of the target media content played in the cross-stream guide card.

5. The method according to claim 1, wherein:
the cross-stream guide card comprises N pieces of cover content, N being a positive integer, the N pieces of cover content being associated with respective N pieces of media content in the second media data stream, and the N pieces of cover content comprising target cover content; and
the displaying the target media content in the second media data stream when the trigger operation is performed on the cross-stream guide card comprises:
displaying the target media content indicated by the target cover content when the trigger operation is performed on the target cover content in the cross-stream guide card.

6. The method according to claim 1, wherein the cross-stream guide card further comprises a content display copy, the content display copy being determined based on historical media content interacted with the user and the media content in the second media data stream.

7. The method according to claim 1, further comprising:
displaying an updated guide card associated with an updated media data stream when a switching operation is performed by the user on the cross-stream guide card, the updated media data stream associated with the updated guide card being different from the second media data stream associated with the cross-stream guide card.

8. The method according to claim 1, further comprising:
when a switching operation is performed on the first media data stream to determined to-be-switched media content, and the to-be-switched media content is determined as last media content in the first media data stream, determining that the interactive operation on the media content in the first media data stream satisfies the media data stream distribution condition,
wherein the displaying the cross-stream guide card comprises:
creating a card display page when the switching operation is performed on the first media data stream and the interactive operation performed on the media content in the first media data stream satisfies the media data stream distribution condition; and
displaying the cross-stream guide card on the card display page.

9. The method according to claim 1, further comprising:
determining that the interactive operation performed on the first media data stream satisfies the media data stream distribution condition when an unviewed behavior or a switching behavior is detected, wherein:
the switching behavior indicates that an interval duration of the switching operation on media content in the first media data stream is less than or equal to a switching duration threshold; and
the displaying the cross-stream guide card comprises:
displaying the cross-stream guide card on a page displaying the media content in the first media data stream when the interactive operation performed on the first media data stream satisfies the media data stream distribution condition.

10. The method according to claim 6, further comprising:
obtaining the historical media content and historical interaction information for the historical media content;
performing feature extraction on the historical media content to obtain a historical content feature vector;
performing feature extraction on the historical interaction information to obtain a historical interaction feature vector;
performing vector concatenation on the historical content feature vector and the historical interaction feature vector, to obtain a historical result feature vector;
performing feature extraction on one or more pieces of to-be-recommended media content in a media content library, to obtain a media content feature vector;
performing attention processing on the historical result feature vector and the media content feature vector, to obtain an attention score corresponding to each of the one or more pieces of to-be-recommended media content; and
encapsulating, into the second media data stream based on the attention score, media content in the one or more pieces of the to-be-recommended media content that satisfies a recommendation condition.

11. The method according to claim 1, wherein:
the first media data stream comprises a plurality of data items arranged in a sequence, the plurality of data items corresponding to a plurality of pieces of media content in the first media data stream and the cross-stream guide card, and
the method further comprises:
traversing, when the interactive operation is performed on the first media data stream, the plurality of data items in the first media data stream in the sequence based on a position of currently displayed media content of the plurality of pieces of media content in the first media data stream;
switching, when a first data item of the plurality of data items obtained by traversing is one of the plurality of pieces of media content, the currently displayed media content to the one of the plurality of pieces of media content obtained by traversing; and
determining that the interactive operation on the first media data stream satisfies the media data stream distribution condition when the first data item obtained by traversing is the cross-stream guide card.

12. The method according to claim 11, wherein:
the method further comprises determining a card status of the cross-stream guide card as a redirected state when the trigger operation is performed on the cross-stream guide card;
the determining that the interactive operation on the first media data stream satisfies the media data stream distribution condition when the first data item obtained by traversing is the cross-stream guide card comprises:
detecting the card status of the cross-stream guide card that is indicated by the first data item;
hiding the cross-stream guide card and traversing a second data item of the plurality of data items when the card status of the cross-stream guide card is the redirected state; and
determining that the interactive operation on the first media data stream satisfies the media data stream distribution condition when the second data item is a second cross-stream guide card with a card status of a non-redirected state; and
the displaying the cross-stream guide card comprises:
displaying the second cross-stream guide card with the card status of the non-redirected state.

13. The method according to claim 11, wherein the determining that the interactive operation on the first media data stream satisfies the media data stream distribution condition when the first data item obtained by traversing is the cross-stream guide card comprises:
performing, when the first data item obtained by traversing is the cross-stream guide card and a card status of the cross-stream guide card is a non-redirected state, an availability check on media content in the cross-stream guide card;
hiding the cross-stream guide card and traversing a second data item when the media content in the cross-stream guide card fails the availability check; and
determining that the interactive operation on the first media data stream satisfies the media data stream distribution condition when the second data item is a second cross-stream guide card and the second cross-stream guide card (i) has a card status of a non-redirected state and (ii) passes the availability check; and
the displaying the cross-stream guide card comprises:
displaying the second cross-stream guide card that has the card status of the non-redirected state and passes the availability check.

14. The method according to claim 1, wherein the displaying the cross-stream guide card when the interactive operation performed on the first media data stream satisfies the media data stream distribution condition comprises:
performing a media content availability check on the cover content in the cross-stream guide card when the interactive operation performed on the first media data stream satisfies the media data stream distribution condition;
when the cover content in the cross-stream guide card satisfies a content availability condition according to the media content availability check,
displaying the cross-stream guide card comprising the cover content; and
when the cover content in the cross-stream guide card does not satisfy the content availability condition,
obtaining a media identifier corresponding to the cover content;
determining, as new target media content in the second media data stream, media content that is adjacent to a position of the media identifier and satisfies the content availability condition;
generating new cover content based on the new target media content; and
displaying another cross-stream guide card comprising the new cover content when the cover content in the cross-stream guide card does not satisfy the content availability condition.

15. The method according to claim 14, further comprising:
determining that the cover content in the cross-stream guide card does not satisfy the content availability condition when the target media content indicated by the cover content in the cross-stream guide card does not exist in a media content library, or a data state of the target media content in the media content library is an invalid state.

16. The method according to claim 2, further comprising:
switching, when a display completion operation is performed on the second media data stream associated with the target guide card, a page displaying the media content in the second media data stream to a page displaying the cross-stream guide card;
determining a card status of the target guide card as a redirected state;
obtaining Q cross-stream guide cards with a card status a non-redirected state from the plurality of cross-stream guide cards in the first media data stream; and
displaying the Q cross-stream guide cards on the page displaying the cross-stream guide card, Q being a positive integer less than M.

17. The method according to claim 1, further comprising:
setting, when a trigger operation is performed on a first function item, the first function item to be in a selected state; and
displaying media content in the first media data stream according to the first function item, the first function item being configured to obtain the media content in the first media data stream through screening by using a first type, wherein:
the displaying the target media content in the second media data stream when the trigger operation is performed on the cross-stream guide card comprises:
canceling the selected state of the first function item;
setting a second function item to be in the selected state; and
displaying the target media content in the second media data stream according to the second function item, when the trigger operation is performed on the cross-stream guide card, the second function item being configured to obtain the media content in the second media data stream through screening based on a second type.

18. The method according to claim 1, wherein:
media content in the first media data stream is under a first theme, and
the displaying the cross-stream guide card when the interactive operation is performed on the first media data stream satisfies the media data stream distribution condition comprises:
displaying theme information of one or more second theme when the interactive operation is performed on the media content in the first media data stream satisfies the media data stream distribution condition; and
displaying, when a selection instruction is performed on target theme information in the theme information of the one or more second theme, the cross-stream guide card corresponding to the target theme information.

19. An apparatus for data processing, comprising:
processing circuitry configured to:
display a cross-stream guide card of a plurality of cross-stream guide cards in a first media data stream when an interactive operation performed by a user on the first media data stream satisfies a media data stream distribution condition, the cross-stream guide card being associated with a second media data stream of a plurality of second media data streams, the media data stream distribution condition indicating whether a watching duration or an interaction frequency associated with the interactive operation of the user meets a threshold value;
display target media content in the second media data stream when a trigger operation is performed by the user on the cross-stream guide card, the target media content including cover content of the cross-stream guide card; and
display media content in the second media data stream and the target media content when a switching operation is performed by the user on the target media content.

20. A non-transitory computer readable storage medium storing instructions which, when executed by at least one processor, cause the at least one processor to perform:
displaying a cross-stream guide card of a plurality of cross-stream guide cards in a first media data stream when an interactive operation performed by a user on the first media data stream satisfies a media data stream distribution condition, the cross-stream guide card being associated with a second media data stream of a plurality of second media data streams, the media data stream distribution condition indicating whether a watching duration or an interaction frequency associated with the interactive operation of the user meets a threshold value;
displaying target media content in the second media data stream when a trigger operation is performed by the user on the cross-stream guide card, the target media content including cover content of the cross-stream guide card; and
displaying media content in the second media data stream and the target media content when a switching operation is performed by the user on the target media content.
